(19) United States
(12) Patent Application Publication
(10) Pub. No.: US 2025/0164962 A1
(43) Pub. Date: May 22, 2025

(54) ARTIFICIAL INTELLIGENT-BASED OPTIMAL OPERATION NUMBER CONTROL SYSTEM AND METHOD FOR INCREASING OPERATION EFFICIENCY OF INDUSTRIAL BOILERS

(71) Applicant: Korea Electronics Technology Institute, Seongnam-si (KR)

(72) Inventors: Seung Hyeon PARK, Yongin-si (KR); Ki Woong KWON, Seoul (KR); Sang Hun KIM, Suwon-si (KR)

(73) Assignee: Korea Electronics Technology Institute, Seongnam-si (KR)

(21) Appl. No.: 18/951,016

(22) Filed: Nov. 18, 2024

(30) Foreign Application Priority Data
Nov. 21, 2023 (KR) 10-2023-0161990

(51) Int. Cl. G05B 19/18

(52) U.S. Cl. CPC G05B 19/182

(57) ABSTRACT

Provided are AI-based optimal operation number control system and method for increasing operation efficiency of industrial boilers. A boiler control method according to an embodiment includes: collecting operation data of boilers; deriving operating boiler combinations by inputting the collected operation data to an AI model that is trained to receive operation data and to derive operating boiler combinations; and controlling operation of the boilers according to the derived operating boiler combinations. Accordingly, by analyzing operating conditions changeable according to a schedule of the field and using the operating conditions for deriving a control value, operation efficiency of industrial boilers are increased.

### CROSS-REFERENCE TO RELATED APPLICATION(S) AND CLAIM OF PRIORITY

This application is based on and claims priority under 35 U.S.C. § 119 to Korean Patent Application No. 10-2023-0161990, filed on Nov. 21, 2023, in the Korean Intellectual Property Office, the disclosure of which is herein incorporated by reference in its entirety.

### BACKGROUND

### Field

The disclosure relates to an industrial boiler operation control technology, and more particularly, to a method for increasing operation efficiency of industrial boilers by defining operation efficiency of industrial boilers and deriving an optimal operation number combination through data analysis.

### Description of Related Art

Industrial boilers are operated to make required loads be shared by several boilers in order to reduce heat loss. For example, when loads of 10 tons are required, four boilers each of which corresponds to loads of 2.5 tons may be installed, and, when loads of 5 tons are required, two boilers may be installed, and when loads of 7.5 tons are required, three boilers may be installed. When boilers are operated in this way, operation number control may be needed.

A related-art operation number control method may be to turn on and turn off in sequence according to an order and loads which are defined at time of installation in the industrial field. The order and loads may be defined through tests at a manufacturer factory, and there is difficulty in responding to variability in the loads of the field or change in the performance of boilers.

Accordingly, there is a demand for a technology that reduces energy consumption by grasping change in operation efficiency, caused by change in the performance of boilers even when the boilers have the same capacity, and deriving optimal operation number control according to characteristics of the field.

### SUMMARY

The disclosure has been developed in order to solve the above-described problems, and an object of the disclosure is to provide, as a solution for enhancing operation efficiency of industrial boilers, a method for defining efficiency reflecting characteristics of the field, rather than efficiency at a test step at a manufacturer factory, and deriving conditions for operating with high efficiency and operation number control values under the conditions through data analysis.

To achieve the above-described object, a boiler control method according to an embodiment of the disclosure may include: collecting operation data of boilers; deriving operating boiler combinations by inputting the collected operation data to an AI model that is trained to receive operation data and to derive operating boiler combinations; and controlling operation of the boilers according to the derived operating boiler combinations.

Controlling may include equally controlling boilers that are designated as operating boilers in the operating boiler combinations, and collecting may include collecting the operation data from any one of the operating boilers.

The collected operation data MAY BE operation data which has a correlation with boiler efficiency greater than or equal to a reference value.

The boiler efficiency may be calculated by the following equation:

Boiler Efficiency=(Water Supply for Unit Time)/(Amount of Fuel for Unit Time).

The correlation between the operation data and the boiler efficiency may be analyzed through a PCC method.

Collecting may include collecting a boiler pressure, an exhaust gas temperature, a boiler body temperature, a scale temperature, an external air temperature, a water temperature, a damper angle.

The AI model may be trained with operation data which is reprocessed after being collected from boilers installed in the field.

A part of the collected operation data may be reprocessed by summing for a unit time, and another part may be reprocessed into a median value within the unit time, and a still another part may be reprocessed with a last value before collection.

The boilers may have a common steam header, and boilers may be additionally installed.

According to another aspect of the disclosure, there is provided a boiler control system including: a control system configured to collect operation data of boilers, and to derive operating boiler combinations by inputting the collected operation data to an AI model that is trained to receive operation data and to derive operating boiler combinations; and a controller configured to control operations of the boilers according to the operating boiler combinations derived by the control system.

According to still another aspect of the disclosure, there is provided an optimal boiler operation number control system including: a communication unit configured to collect operation data of boilers; and a processor configured to derive operating boiler combinations by inputting the collected operation data to an AI model that is trained to receive operation data and to derive operating boiler combinations.

As described above, compared to a related-art method in which efficiency of boilers measured at a test step are not used after installation, the method according to an embodiment of the disclosure may increase operation efficiency of industrial boilers by defining operation efficiency according to the industrial field having various operation conditions and variability in the loads, and analyzing operating conditions changeable according to a schedule of the field and using the operating conditions for deriving a control value.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an industrial boiler operation number control system;

FIG. 2 is a view illustrating reprocessing of collected data;

FIG. 3 is a view illustrating operation efficiency analysis (load vs efficiency, for each operation number);

FIG. 4 is a view illustrating operating boiler operation number combinations;

FIG. 5 is a view illustrating data sets of a learning model; and

FIG. 6 is a view illustrating an optimal operation number control system.

### DETAILED DESCRIPTION

Hereinafter, the disclosure will be described in more detail with reference to the accompanying drawings.

Embodiments of the disclosure provide an AI-based optimal operation number control system and method for increasing operation efficiency of industrial boilers. The disclosure relates to a technology that increases operation efficiency of industrial boilers by defining operation efficiency and deriving an optimal operation number control value through data analysis.

Specifically, operating conditions indicating high efficiency are found through analysis of a correlation with efficiency defined by past operation data, and an optimal operation number control value indicating high efficiency under a current operating condition is derived based on the found operating conditions, and boilers are operated.

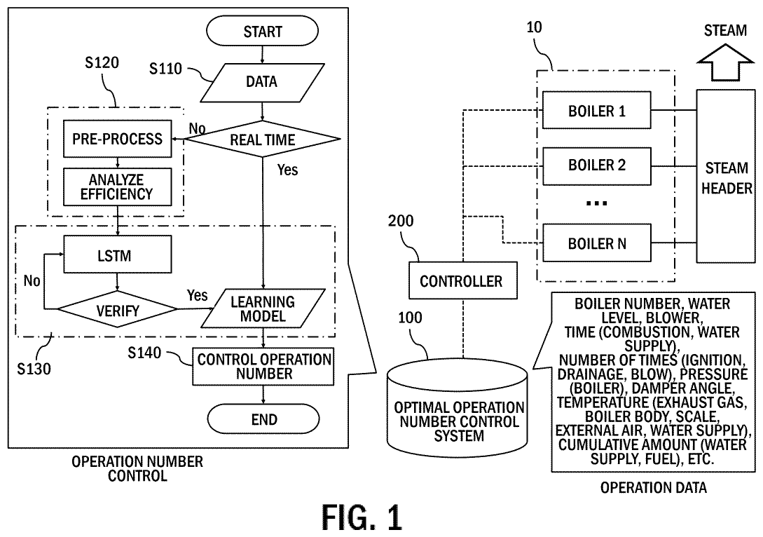

FIG. 1 is a view illustrating an AI-based industrial boiler control system according to an embodiment of the disclosure. The industrial boiler control system according to an embodiment includes an optimal operation number control system 100 and a controller 200.

Boilers 10 to be controlled have a common steam header and thus it is possible to additionally install boilers in parallel according to required loads. The controller 200 is configured to control operation of the boilers 10 and the optimal operation number control system 100 determines an optimal operation number of industrial boilers according to a method illustrated on the left of FIG. 1.

The optimal operation number control of industrial boilers may include 1) a step of collecting operation data of industrial boilers (S110), 2) a step of defining efficiency based on operation data and extracting relevant data (S120), 3) a step of generating a model for deriving an optimal operating condition for efficiency based on AI (S130), and a step of automatically controlling an operation number.
1) Collecting operation data of industrial boilers

Operation data generated in industrial boilers are collected through an IoT device and are stored in a database. The data collected through the industrial boilers may include boiler numbers, water levels, blowers, time (combustion, water supply), the number of times (ignition, drainage, blowing), pressure (boiler), damper angle, temperature (exhaust gas, boiler body, scale, external air, water supply), resettable total (water supply, fuel).
2) Defining efficiency based on operation data and extracting relevant data

Operation efficiency of industrial boilers may be acquired through the following equation by using collected operation data. When efficiency of boilers is measured in a related-art method through a test of a manufacturer factory, the measured efficiency may be underutilized since there are not many continuous conditions for water supply and fuel in the actual field, and various and precise measurement sensors are required, which is a difference from the field after installation. Accordingly, the efficiency of boilers is defined with common data collected in the field as shown in the following equation:

Boiler Efficiency=(Water supply for Unit Time)/Amount of Fuel for Unit Time)

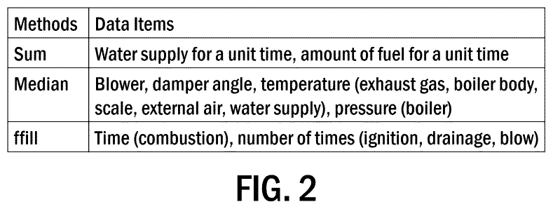

Here, the unit time is 1 hour and water supply for the unit time and the amount of fuel for the unit time are defined with reference to the cumulative amount of collected data. There is a procedure of reprocessing the collected data in the unit time as a pre-processing procedure to make time intervals of the collected data equal. FIG. 2 illustrating a reprocessing method for collected data.

In the case of sum, the existing cumulative amount of collected data is replaced with water supply and an amount of fuel for the unit time of one hour, and then is reprocessed by summing for one hour from a corresponding time. Sum is applied to reprocessing of water supply for the unit time, the amount of fuel for the unit time.

In the case of median, the collected data is reprocessed to a median value that has the largest percentage among various values existing for one hour. Median is applied to reprocessing of a blower, a damper angle, temperature (exhaust gas, boiler body, scale, external air, water supply), pressure (boiler).

In the case of ffill, the collected data is reprocessed with a last value as a statistical value rather than a status value such as time or the number of times. ffill is applied to reprocessing of time (combustion), the number of times (ignition, multiple, blow).

To find operating conditions showing high efficiency, it is necessary to find data items having a high correlation between pre-defined efficiency and operation data. The correlation is analyzed through a Pearson correlation coefficient (PCC) method. As a result, pressure (boiler) and temperature (exhaust gas) have the highest correlation except for the water supply and the amount of fuel for the unit time, which are used for efficiency.

For each boiler, temperature (boiler body, scale, external air, water supply), damper angle are top 10 data items. Accordingly, relevant data items used for deriving operating conditions of high efficiency include pressure (boiler), temperature (exhaust gas, boiler body, scale, external air, water supply), damper angle, and are used for training an optimal driving condition deriving model.
3) Generating a model for deriving an optimal driving condition for efficiency based on AI

Data items that have a higher correlation with efficiency among the reprocessed data are used as an input data set for an AI model. In addition, the load is used as a reference for comparing conditions of high efficiency in the past operation data. Typically, the load is acquired with reference to an amount of stem produced in a boiler. However, the sensor for measuring an amount of steam is generally expensive and industrial boilers with the corresponding sensors barely exist, and accurate measurement of the amount of steam is realistically impossible.

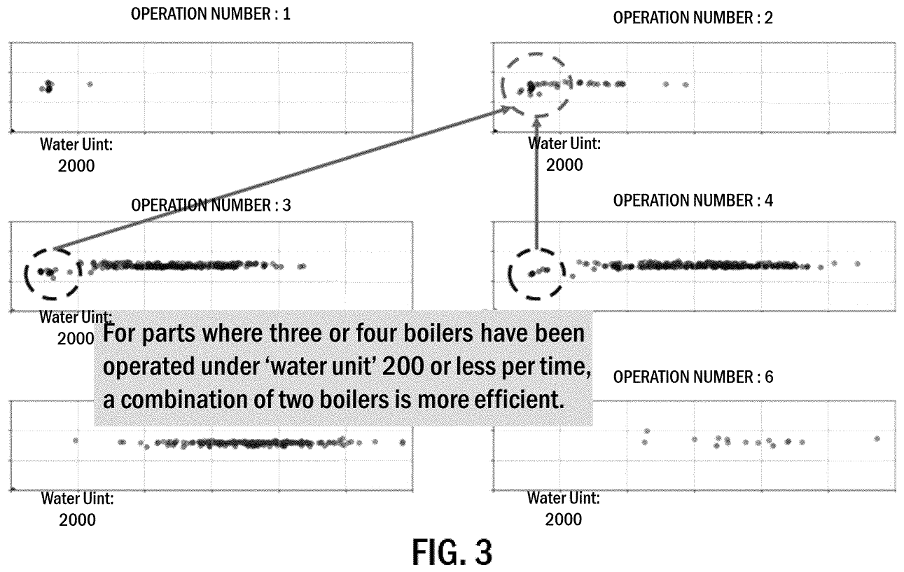

In embodiments of the disclosure, the load is used as a reference on the assumption that water supply for the unit time, that is, water supplied to a boiler, is all changed to steam. The load defined in this way is calculated for each boiler and it is calculated how much load each boiler operates with for the unit time, and the operation number of boilers operated for the unit time is calculated based on the load. FIG. 3 is a view illustrating analysis of loads and efficiency by operation number, with additionally improved efficiency.

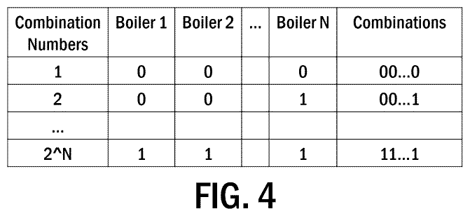

In addition, a driving/non-driving state is displayed as 1 or 0 to make combinations of operation number control, and operating boiler operation number combinations are made as shown in FIG. 4.

Conditions showing high efficiency for each load are acquired based on the pre-defined efficiency and load and the combinations thereof, and final operation number control combinations showing high efficiency are derived by comparing combinations at that time. Since there are various operating conditions under the same load and the same operation number, a model for deriving an optimal operation number control combination by using AI is made.

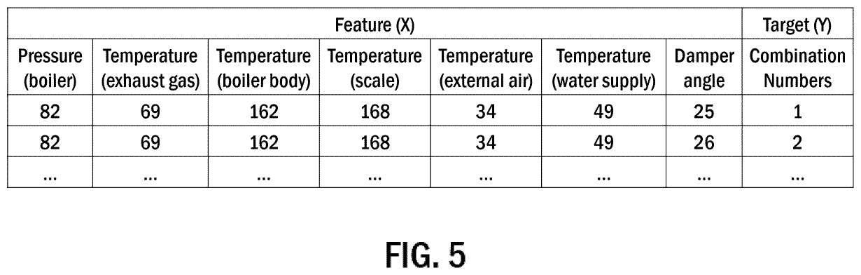

FIG. 5 illustrate datasets necessary for training an AI model. Input data [Feature (X)] of the AI model is boiler pressure, exhaust gas temperature, boiler body temperature, scale temperature, external air temperature, water supply temperature, damper angle, and output data (label data) is operating boiler combination numbers.

A long short-term memory (LSTM) may be used as the learning model. This is to use characteristics of the model capable of appropriately reflecting change for a short time such as a chemical reaction caused by combustion, and change for a long time such as aging.
4) Auto operation number control

By inputting information of Feature (X) generated in an operation process to the trained model, an optimal combination number is finally obtained, and a boiler corresponding to the combination is operated. As a result, data is replaced with a new control value reflecting characteristics of the field, and the operation number of boilers are continuously controlled.

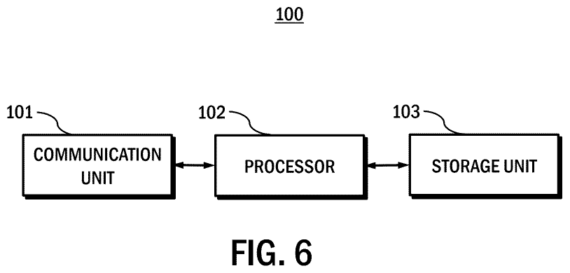

FIG. 6 is a view illustrating a configuration of the optimal operation number control system 100 shown in FIG. 1. The optimal operation number control system 100 according to an embodiment may be implemented by a server system including a communication unit 101, a processor 120, and a storage unit 103 as shown in the drawing.

The communication unit 101 is a communication interface for connecting to an external network or an external device, and collects operation data of boilers. Since boilers are equally controlled in embodiments of the disclosure, operation data may be collected from any one of the operating boilers.

According to the procedure illustrated on the left of FIG. 1 described above, the processor 230 may collect operation data of industrial boilers, may extract operation data having a high correlation with boiler efficiency, may derive an optimal operation number combination for efficiency based on AI, and may automatically control the operation number of operating boilers according to the derived combination.

The storage unit 250 provides a storage space necessary for functions and operations of the processor 230.

Up to now, the AI-based optimal operation number control system and method for increasing operation efficiency of industrial boilers have been described in detail with reference to preferred embodiments.

In the above-described embodiments, for the purpose of enhancing operation efficiency of industrial boilers, efficiency reflecting characteristics of the field rather than efficiency at a test step at a manufacturer factor is defined, and conditions for operating with high efficiency and an operation number control value under the conditions are derived through data analysis.

Specifically, operating conditions showing high efficiency, reflecting characteristics of the field, are continuously found through past operation data analysis, and operation number control of boilers operating in sequence according to the order and loads defined at the time of installation is automatically replaced with a new control value reflecting characteristics of the field.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A boiler control method comprising:
collecting operation data of boilers;
deriving operating boiler combinations by inputting the collected operation data to an AI model that is trained to receive operation data and to derive operating boiler combinations; and
controlling operation of the boilers according to the derived operating boiler combinations.

2. The boiler control method of claim 1, wherein controlling comprises equally controlling boilers that are designated as operating boilers in the operating boiler combinations, and
wherein collecting comprises collecting the operation data from any one of the operating boilers.

3. The boiler control method of claim 1, wherein the collected operation data is operation data which has a correlation with boiler efficiency greater than or equal to a reference value.

4. The boiler control method of claim 3, wherein the boiler efficiency is calculated by the following equation:
Boiler Efficiency=(Water Supply for Unit Time)/(Amount of Fuel for Unit Time).

5. The boiler control method of claim 3, wherein the correlation between the operation data and the boiler efficiency is analyzed through a PCC method.

6. The boiler control method of claim 3, wherein collecting comprises collecting a boiler pressure, an exhaust gas temperature, a boiler body temperature, a scale temperature, an external air temperature, a water temperature, a damper angle.

7. The boiler control method of claim 1, wherein the AI model is trained with operation data which is reprocessed after being collected from boilers installed IN the field.

8. The boiler control method of claim 7, wherein a part of the collected operation data is reprocessed by summing for a unit time, and another part is reprocessed into a median value within the unit time, and a still another part is reprocessed with a last value before collection.

9. The boiler control method of claim 1, wherein the boilers have a common steam header, and boilers are additionally installed.

10. A boiler control system comprising:
a control system configured to collect operation data of boilers, and to derive operating boiler combinations by inputting the collected operation data to an AI model that is trained to receive operation data and to derive operating boiler combinations; and
a controller configured to control operations of the boilers according to the operating boiler combinations derived by the control system.

11. An optimal boiler operation number control system comprising:
a communication unit configured to collect operation data of boilers; and
a processor configured to derive operating boiler combinations by inputting the collected operation data to an AI model that is trained to receive operation data and to derive operating boiler combinations.
